(19) United States
(12) Patent Application Publication
(10) Pub. No.: US 2011/0087983 A1
(43) Pub. Date: Apr. 14, 2011

(54) MOBILE COMMUNICATION TERMINAL HAVING TOUCH INTERFACE AND TOUCH INTERFACE METHOD

(75) Inventor: Sang Hoon SHIM, Goyang-si (KR)

(73) Assignee: PANTECH CO., LTD., Seoul (KR)

(21) Appl. No.: 12/793,164

(22) Filed: Jun. 3, 2010

(30) Foreign Application Priority Data
Oct. 14, 2009 (KR) 10-2009-0097840

(51) Int. Cl. G06F 3/048

(52) U.S. Cl. 715/769; 715/811; 715/825; 345/173; 455/566; 715/863

(57) ABSTRACT

A mobile communication terminal having a touch interface and a touch interface method provide a touch selection process for the purpose of menu selection. The mobile communication terminal includes a touch unit to generate a touch signal in response to a received touch, a touch signal determination unit to receive the touch signal from the touch unit, and to determine whether the touch is maintained or released, and an execution menu processing unit to generate an execution menu list with respect to data corresponding to the touch signal if the touch is determined to be maintained, to sequentially activate respective execution menus of the execution menu list in accordance with a menu change time, and to transmit an execution command with respect to the activated execution menu to execute the activated execution menu to a control unit if the touch is determined to be released.

### CROSS-REFERENCE TO RELATED APPLICATION

This application claims priority from and the benefit of Korean Patent Application No. 10-2009-0097840, filed on Oct. 14, 2009, which is hereby incorporated by reference for all purposes as if fully set forth herein.

### BACKGROUND

1. Field

Exemplary embodiments of the present invention relate to a mobile communication terminal providing a touch interface, and a method of providing the touch interface.

2. Discussion of the Background

In general, a touch screen or a touch panel may be a user interface for electronic equipment and may be one of a variety of displays thereof. A user may control the electronic equipment by directly contacting the screen or panel with a finger or a pen without using supplementary peripheral devices, such as a keyboard, a mouse, and the like.

Currently, a mobile communication terminal has been developed as a multimedia device that provides various functions. Such mobile communication terminal may store great amounts of complex types of data in accordance with the various functions. Accordingly, the mobile communication terminal may provide a user interface through which a user is able to more readily verify functions and perform the verified functions. In particular, the mobile communication terminal may provide an intuitive user interface through a touch screen.

In the conventional mobile communication terminal, when a plurality of execution menus with respect to specific data are present, the mobile communication terminal may receive an input of a menu button with respect to the specific data, display an execution menu list, and perform an execution menu selected from the execution menu list.

However, the conventional mobile communication terminal may have problems in that many key inputs may be used to perform a function with respect to the specific data. Also, the conventional mobile communication terminal including a touch screen may have an inconvenience in which a user is required to perform a touch operation while moving the contact point around on the touch screen to perform the function with respect to the specific data. In particular, during movement, a user may need to concentrate a touch operation performed many times to perform a desired function, and the mobile communication may not satisfactorily recognize the touch operation.

### SUMMARY

Exemplary embodiments of the present invention provide a mobile communication terminal providing a touch interface, and a method of providing the touch interface, which may reduce a touch selection process performed by a user for the purpose of menu selection in the mobile communication terminal including a touch screen.

Exemplary embodiments of the present invention provide a mobile communication terminal providing a touch interface in which it is possible to perform a desired menu through a single touch in a mobile communication terminal including a touch screen.

Exemplary embodiments of the present invention provide a mobile communication terminal providing a touch interface in which it is possible to configure a displayed execution menu list in accordance with an execution history.

Additional features of the invention will be set forth in the description which follows, and in part will be apparent from the description, or may be learned by practice of the invention.

An exemplary embodiment of the present invention discloses a mobile communication terminal having a touch interface, including: a touch unit to generate a touch signal in response to a received touch; a touch signal determination unit to receive the touch signal from the touch unit, and to determine whether the touch is maintained or released; and an execution menu processing unit to generate an execution menu list with respect to data corresponding to the touch signal if the touch is determined to be maintained, to sequentially activate respective execution menus of the execution menu list in accordance with a menu change time, and to transmit an execution command with respect to the activated execution menu to a control unit to execute the activated execution menu if the touch is determined to be released.

An exemplary embodiment of the present invention discloses a touch interface method performed in a mobile communication terminal, the touch interface method including: outputting a data list with respect to a menu provided in the mobile communication terminal; receiving a touch with respect to any one data from the data list; determining whether the touch is maintained; generating an execution menu list with respect to the data if the touch is maintained, and displaying the generated execution menu list; sequentially activating respective execution menus of the execution menu list in accordance with a menu change time; and performing the activated execution menu if the touch is released.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a diagram illustrating a configuration of a mobile communication terminal according to an exemplary embodiment of the present invention.

FIG. 2 is a flowchart illustrating a touch interface method according to an exemplary embodiment of the present invention.

FIG. 3 is a flowchart illustrating a touch interface method according to an exemplary embodiment of the present invention.

FIG. 4A, FIG. 4B, FIG. 4C, and FIG. 4D are diagrams illustrating a touch interface method of a mobile communication terminal according to an exemplary embodiment of the present invention.

### DETAILED DESCRIPTION OF THE ILLUSTRATED EMBODIMENTS

Exemplary embodiments are disclosed herein. However, specific structural and functional details disclosed herein are merely representative for purposes of describing exemplary embodiments. Exemplary embodiments may, however, be embodied in many alternate forms and should not be construed as limited to only the embodiments set forth herein.

Accordingly, while exemplary embodiments are capable of various modifications and alternative forms, embodiments thereof are shown by way of example in the drawings and will herein be described in detail. It should be understood, however, that there is no intent to limit the exemplary embodiments to the particular forms disclosed, but to the contrary, exemplary embodiments are to cover all modifications, equivalents, and alternatives falling within the scope of the exemplary embodiments. Like numbers refer to like elements throughout the description of the figures.

It will be understood that, although the terms first, second, etc., may be used herein to describe various elements, these elements should not be limited by these terms. These terms are only used to distinguish one element from another. For example, a first element could be termed a second element, and, similarly, a second element could be termed a first element, without departing from the scope of the exemplary embodiments. As used herein, the term “and/or” includes any and all combinations of one or more of the associated listed items.

The terminology used herein is for the purpose of describing particular embodiments only and is not intended to be limiting of the exemplary embodiments. As used herein, the singular forms “a”, “an” and “the” are intended to include the plural forms as well, unless the context clearly indicates otherwise. It will be further understood that the terms “comprises”, “comprising”, “includes”, and/or “including”, when used herein, specify the presence of stated features, integers, steps, operations, elements, and/or components, but do not preclude the presence or addition of one or more other features, integers, steps, operations, elements, components, and/or groups thereof.

Hereinafter, exemplary embodiments of the present invention will be described in more detail with reference to the accompanying drawings.

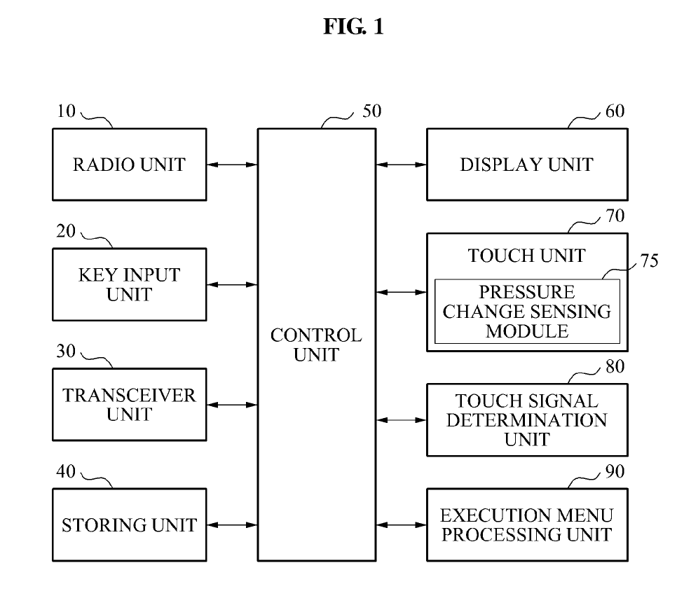

FIG. 1 is a diagram illustrating a configuration of a mobile communication terminal according to an exemplary embodiment of the present invention. Referring to FIG. 1, the mobile communication terminal may include a radio unit 10, a key input unit 20, a transceiver unit 30, a storing unit 40, a control unit 50, a display unit 60, a touch unit 70, a touch signal determination unit 80, and an execution menu processing unit 90. The touch unit 70, the touch signal determination unit 80, and the execution menu processing unit 90 may be provided to implement a touch interface method according to exemplary embodiments of the present invention.

In FIG. 1, the touch unit 70, the touch signal determination unit 80, and the execution menu processing unit 90 are shown as separate blocks but they are not limited thereto. That is, functions performed by the touch signal determination unit 80 and the execution menu processing unit 90 may be integrally performed by a control unit 50, and the touch unit 70 may be included in a display unit 60.

The radio unit 10 may process a radio frequency (RF) signal transmitted/received in a wireless manner. The radio unit 10 may convert image data or voice data into the RF signal to transmit/receive the RF signal.

The key input unit 20 may receive a key input through which operations of the mobile communication terminal are input, such as a video call request, a general call request, data input, and the like. The key input unit 20 may include a button unit on which a key input is performed to input operations.

The transceiver unit 30 may include a microphone and a speaker used if a voice call is performed. Further, the transceiver unit 30 may be used for recording/reproducing of data to/from the mobile communication terminal.

The storing unit 40 may include a Read Only Memory (ROM) and/or a memory used for storing programs and data. The storing unit 40 may store a variety of data, messages, and the like generated in or input to the mobile communication terminal. The storing unit 40 may store commands that are particularly designated to correspond to the key inputs of the key input unit 20.

The display unit 60 may display a variety of display data, messages, and the like generated in or input to the mobile communication terminal. The display unit 60 may display an execution menu list used for providing a one-touch type touch interface. The display unit 60 may also display any variety of data, such as one or more of still/moving images, icons, menus, lists, alerts, text, internet pages, and/or input screens associated with the input of data.

The control unit 50 may control the radio unit 10, the key input unit 20, the transceiver unit 30, the storing unit 40, the control unit 50, the display unit 60, the touch unit 70, the touch signal determination unit 80, and the execution menu processing unit 90. The control unit 50 may include a digital signal processor, a micro processor, and the like.

The touch unit 70 may include a touch screen or a touch panel, and may be an input unit where a touch is received to generate a touch signal. The mobile communication terminal may include the key input unit 20 and/or the touch unit 70, each being an input unit. Also, the touch unit 70 may be implemented on the display unit 60.

The touch unit 70 may generate a touch signal with respect to an input touch. The touch unit 70 may sense the touch by a sensor disposed in accordance with coordinates that are designated on a screen. That is, the mobile communication terminal may compute touch position coordinates of the touch by sensing the touch.

The touch unit 70 may include a pressure change sensing module 75. The pressure change sensing module 75 may sense a pressure change occurring at or around a position where the touch is input, i.e., at or near the computed touch position coordinates. That is, the pressure change sensing module 75 may measure a pressure intensity applied on the computed touch position coordinates to thereby sense a pressure change of a touched position. The pressure change sensing module 75 may generate a pressure intensity signal indicating the measured pressure intensity.

For example, the pressure change sensing module 75 may measure the pressure intensity and generate the pressure intensity signal indicating a strong pressure intensity and a weak pressure intensity, or indicating a strong pressure intensity, moderate pressure intensity, and weak pressure intensity, with respect to a reference value. The pressure change sensing module 75 may measure the pressure intensity and generate pressure signals indicating any number of pressure intensity signals, i.e., strong, moderate, and weak, or very strong, strong, moderate, weak, and very weak.

Also, the pressure change sensing module 75 may measure an intensity of a pressure applied on the computed touch position coordinates to thereby sense a pressure change occurring around the touched position. That is, the pressure change sensing module 75 may measure a pressure intensity at a position where a pressure is applied with respect to the touch position coordinates and may generate a direction selection signal if the measured pressure intensity is equal to or greater than a reference value.

For example, the direction selection signal may be any one of left, right, up, and/or down directions, and combinations thereof, with respect to the touch position coordinates. Further, the direction selection signal may indicate a movement to a portion of the touch unit 70 adjacent to the touch position coordinates.

If a pressure intensity being equal to or greater than the reference value is measured in any one of left, right, up, and down directions with respect to the touch position coordinates, the pressure change sensing module 75 may generate the direction selection signal.

The touch signal determination unit 80 may receive the touch signal from the touch unit 70 and determine whether a touch is maintained or released. Also, the touch signal determination unit 80 may receive the touch signal generated through a drag operation to recognize the received touch signal as a drag signal.

If a touch signal is generated with respect to specific data of an arbitrary data list displayed on the display unit 60, the touch signal determination unit 80 may determine whether the touch signal is consistently generated for a period of time or more. The touch signal determination unit 80 may transmit information about whether the touch is maintained to the execution menu processing unit 90.

Also, the touch signal determination unit 80 may determine whether the consecutively generated touch signal is interrupted after being determined that the touch is maintained. The touch signal determination unit 80 may transmit information about whether the touch signal is interrupted to the execution menu processing unit 90.

The execution menu processing unit 90 may generate an execution menu list with respect to the specific data and may sequentially activate respective execution menus of the execution menu list according to the information received from the touch signal determination unit 80 about whether the touch signal is maintained. That is, the execution menu processing unit 90 may generate the execution menu list with respect to data corresponding to the touch signal if determined that the touch signal is maintained. The execution menu processing unit 90 may sequentially activate the respective execution menus of the execution menu list in accordance with a menu change time. Here, the execution menu processing unit 90 may add a cancel menu in the execution menu list and, thereby, may enable a user to use a cancel function through the sequentially activated menus.

Here, the execution menu processing unit 90 may individually designate the execution menu list with respect to specific data in accordance with a type of the specific data. That is, the execution menu processing unit 90 may generate the execution menu list in accordance with an execution history of the user.

For example, the execution menu processing unit 90 may enable the execution menu list to include execution menus currently performed by the user with respect to specific data, or the execution menu processing unit 90 may enable the execution menu list to include execution menus having a higher execution frequency. That is, the execution menu processing unit 90 may enable the execution menu list to include at least one of execution menus executed for a period with respect to the data, and a number of upper execution menus from among execution menus aligned in an order of the higher execution frequency.

The execution menu processing unit 90 may generate a menu change alarm signal using at least one of a vibration and a sound of the mobile communication terminal if the execution menu is activated.

The execution menu processing unit 90 may receive a pressure intensity signal from the pressure change sensing module 75 to thereby change the menu change time, i.e., a period during which the execution menus are changed.

For example, if the pressure intensity signal is strong, the execution menu processing unit 90 may decrease or minimize the menu change time, thereby increasing a speed in which the execution menus are sequentially activated. Here, the menu change time may be designated to correspond to the pressure intensity signal. That is, the menu change time may correspond to the pressure intensity signal (e.g., strong, moderate, and weak), and thereby may be respectively designated as short, moderate, and long. Although described as strong, moderate, and weak being designated as short, moderate, and long, aspects are not limited thereto such that the different pressure intensity signals may be designated as other menu change times and/or the pressure intensity signals may be more finely or less finely realized to provide more or fewer menu change times.

The execution menu processing unit 90 may receive a direction selection signal from the pressure change sensing module 75 to thereby determine a direction in which the execution menus of the execution menu list are sequentially activated or highlighted. Here, the execution menu list may be displayed in one of a fan-shape type, a semi-circular type, a horizontal movement type, a vertical movement type, and a semitransparent text type according to a setting of a user.

For example, the execution menu processing unit 90 may determine the direction in which the execution menus are sequentially activated in accordance with the direction selection signal (e.g., left/right or up/down) as a type of forward/reverse.

For example, the execution menu processing unit 90 may determine the direction in which the execution menus are sequentially activated in accordance with the direction selection signal (e.g., left, right, up, and down) as a type of left, right, up, and down from a viewpoint of a user.

The execution menu processing unit 90 may receive information about whether the touch is released from the touch signal determination unit 80, and may perform execution menus activated if the touch is released, using the control unit 50. That is, the execution menu processing unit 90 may transmit an execution command with respect to the activated execution menus to the control unit 50 to perform the activated execution menus if the touch signal determination unit 80 has determined that the touch is released. Further, the execution command to execute the activated execution menu may be performed if the touch is released in the execution menu of the execution menu list.

The execution menu processing unit 90 may perform a command concerning a drag signal if receiving the drag signal from the touch signal determination unit 80 before receiving information about whether the touch is released from the touch signal determination unit 80.

For example, the execution menu processing unit 90 may determine that the touch is maintained if a region where the drag signal is generated is included in a touch data region where the touch is maintained. Also, the execution menu processing unit 90 may perform a cancel function if the region where the drag signal is generated is included in a region where data is absent, which is different from the touch data region. Also, the execution menu processing unit 90 may generate an execution menu list with respect to corresponding data to sequentially activate respective execution menus of the execution menu list if the region where the drag signal is generated is included in another touch data region.

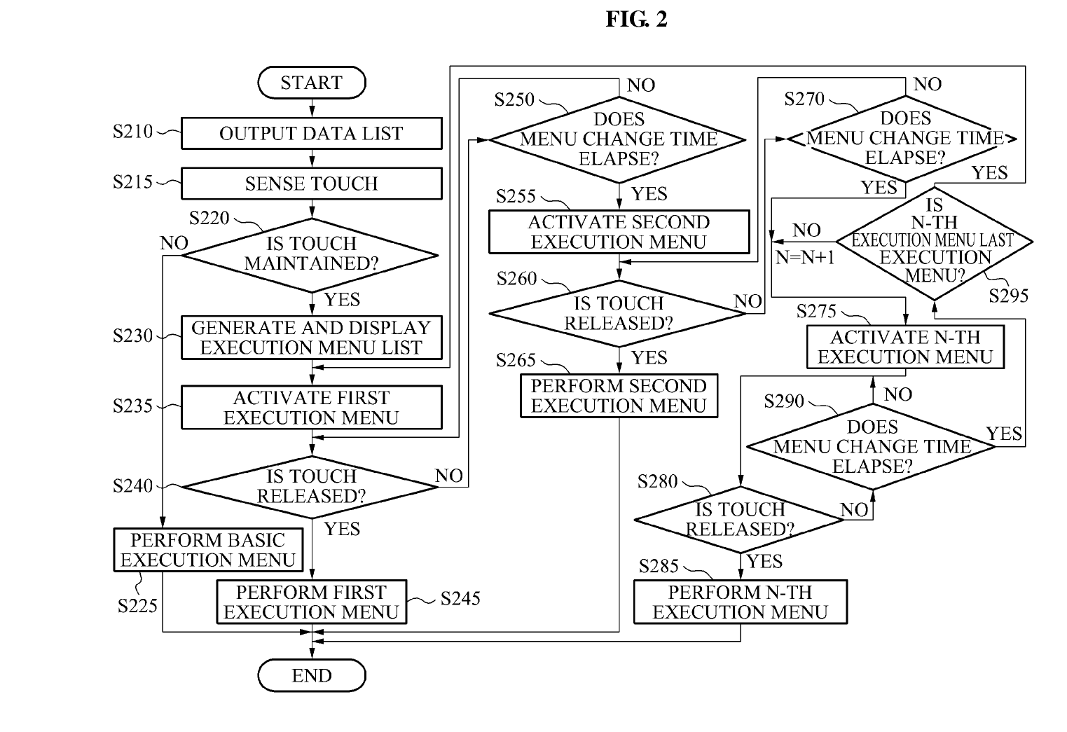

FIG. 2 is a flowchart illustrating a touch interface method according to an exemplary embodiment of the present invention. Referring to FIG. 2, in operation S210, the mobile communication terminal may perform an application selected by a user, and output a data list in accordance with a performed application. For example, the mobile communication terminal may perform a call record-viewing operation selected by the user, and output a data list concerning persons recently called.

Next, in operation S215, the mobile communication terminal may sense a touch with respect to any one data from the output data list.

Next, in operation S220, the mobile communication terminal may determine whether the touch is maintained. In this instance, the mobile communication terminal may determine that the touch is maintained if the touch is maintained for a period of time or more.

In operation S225, the mobile communication terminal may perform a basic execution menu if the touch is not maintained based on the determined result of operation S220. Here, the basic execution menu may be designated by a user or may be any one of execution menus included in an execution menu list.

In operation S230, the mobile communication terminal may generate and display an execution menu list with respect to corresponding data if the touch is maintained based on the determined result of operation S220.

For example, the mobile communication terminal may generate and display an execution menu list with respect to a person to be called or previously called while the touch is being maintained if the data list concerning persons to be called or previously called is output. For example, if the call record-viewing operation is used, the mobile communication terminal may generate and display an execution menu list with respect to a person recently called while the touch is being maintained. The execution menu list may be displayed or output according to an input touch or a pressing of a button; however, aspects are not limited thereto. The execution menu list may include at least one of “send message”, “register as spam”, “register as call rejection”, “store phone number”, “delete”, “delete all”, and “cancel”.

Next, in operation S235, the mobile communication terminal may activate or highlight a first execution menu from the execution menu list. In this instance, the mobile communication terminal may generate a menu change alarm signal using at least one of a vibration and a sound of the mobile communication terminal if the first execution menu is activated. The mobile communication terminal may further generate the menu change alarm signal while a second execution menu to an N-th execution menu is activated.

For example, the mobile communication terminal may display the execution menu list in a vertical movement type menu, and the mobile communication terminal may activate the execution menus in a direction from a top to a bottom of the execution menu list. In this instance, the first execution menu may be a top execution menu of the execution menu list.

Next, in operation S240, the mobile communication terminal may determine whether the touch is released. In operation S245, the mobile communication terminal may perform the activated first execution menu if the mobile communication terminal determines that the touch is released. Further, the activated first execution menu may be performed if the touch is released in the execution menu of the execution menu list, but aspects are not limited thereto.

Hereinafter, the mobile communication terminal may perform a command concerning a drag signal if receiving the drag signal before receiving information indicating that the touch is released.

For example, the mobile communication terminal may determine that the touch is maintained if a region where the drag signal is generated is included in a touch data region where the touch is maintained. Also, the mobile communication terminal may perform a cancel function if the region where the drag signal is generated is included in a region where touch data is absent, which is different from the touch data region. Also, if the region where the drag signal is generated is included in another touch data region, the mobile communication terminal may generate an execution menu list with respect to corresponding data, and sequentially activate respective execution menus of the execution menu list.

In operation S250, the mobile communication terminal may determine whether a menu change time elapses when the touch is not released based on the determined result of operation S240.

In operation S255, the mobile communication terminal may activate or highlight a second execution menu when the menu change time elapses.

Next, in operation S260, the mobile communication terminal may determine whether the touch is released. In operation S265, the mobile communication terminal may perform the activated second execution menu when the mobile communication terminal determines that the touch is released.

In operation S270, the mobile communication terminal may determine whether the menu change time elapses when the touch is not released based on the determined result of operation S260.

In operation S275, the mobile communication terminal may activate or highlight an N-th execution menu when the menu change time elapses. Here, N may be a number of execution menus included in the execution menu list.

Next, in operation S280, the mobile communication terminal may determine whether the touch is released. In operation S285, the mobile communication terminal may perform the N-th execution menu when the mobile communication terminal determines that the touch is released.

In operation S290, the mobile communication terminal may determine whether the menu change time elapses when the touch is not released based on the determined result of operation S260.

When the menu change time elapses based on the determined result of operation S290, the mobile communication terminal may determine whether the N-th execution menu is a last execution menu of the execution menu list in operation S295. If it is determined that the N-th execution menu is not the last execution menu of the execution menu list, one (1) is added to N and the mobile communication terminal may proceed to repeat operations S275, S280, and S290. If it is determined that the N-th execution menu is the last execution menu of the execution list, the mobile communication terminal may advance to operation S235.

The mobile communication terminal may sequentially activate respective execution menus included in an execution menu list and perform an execution menu corresponding to a point in time when the touch is released. Also, the mobile communication terminal may repeatedly activate the execution menus until the touch is released or may terminate a display of the execution menu list when the touch is not released for a period of time.

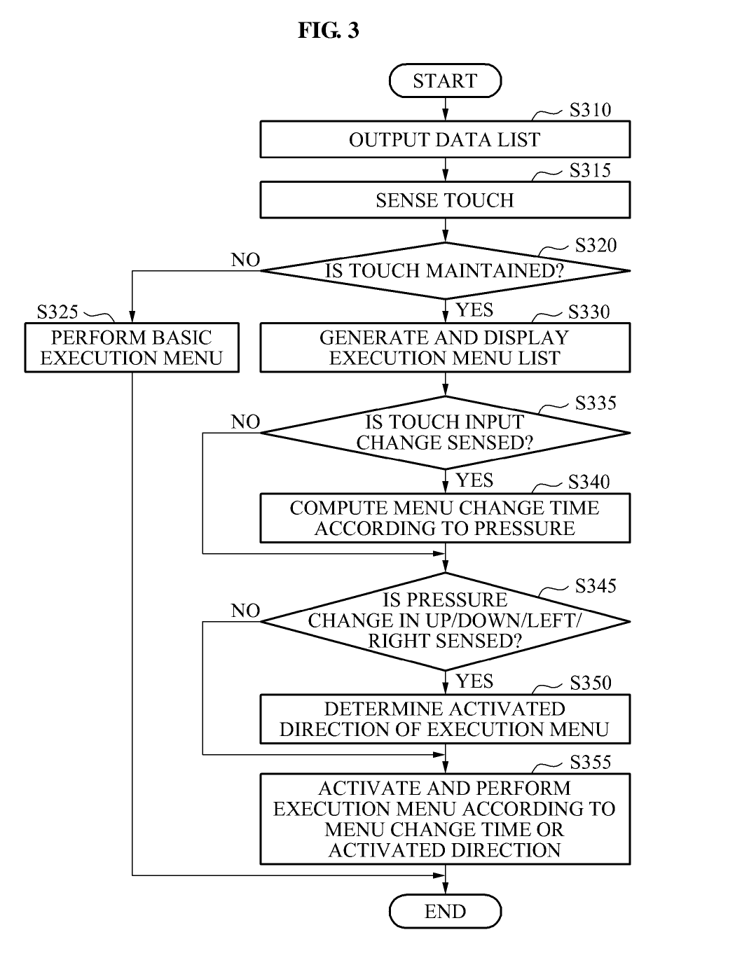

FIG. 3 is a flowchart illustrating a touch interface method according to an exemplary embodiment of the present invention. Hereinafter, repeated descriptions with regard to the above described the touch interface method will be briefly made or omitted. Referring to FIG. 3, in operation S310, the mobile communication terminal may perform an application selected by a user and output a data list in accordance with the performed application. The data list may be output according to an input touch or a pressing of a button. Next, in operation S315, the mobile communication terminal may sense a touch with respect to any one data from the output data list.

Next, in operation S320, the mobile communication terminal may determine whether the touch is maintained.

In operation S325, the mobile communication terminal may perform a basic execution menu when the touch is not maintained based on the determined result of operation S320.

In operation S330, the mobile communication terminal may generate and display an execution menu list with respect to corresponding data when the touch is maintained based on the determined result of operation S320.

In operation S335, the mobile communication terminal may determine that a touch pressure change is sensed in touch position coordinates of the touch. That is, the mobile communication terminal may measure a pressure intensity applied on the touch position coordinates to thereby sense the touch pressure change occurring at a touched position.

In operation S340, the mobile communication terminal may compute a menu change time corresponding to the pressure intensity when the touch pressure change is sensed based on the determined result of operation 335. The mobile communication terminal may apply the computed menu change time.

For example, the mobile communication terminal may measure the pressure intensity to generate a pressure intensity signal indicating a strong and weak intensity, or indicating a strong, moderate, and weak intensity, in accordance with a reference value and change the menu change time to correspond to the pressure intensity signal, thereby changing a speed in which the execution menus are sequentially activated.

Next, in operation S345, the mobile communication terminal may measure an intensity of a pressure applied around the touch position coordinates to thereby determine whether a touch pressure change around the touched position is sensed. That is, when a pressure intensity equal to or greater than a reference value is measured in any one of left, right, up, and down, portions, or combinations thereof, with respect to the touch position coordinates of the touch, the mobile communication terminal may generate a direction selection signal.

Next, in operation S350, the mobile communication terminal may determine a direction in which the execution menus are sequentially activated in the execution menu list using the direction selection signal. Here, the execution menu list may be displayed in one of a fan-shape type, a semi-circular type, a horizontal movement type, a vertical movement type, and a semitransparent text type based on a setting. For example, the mobile communication terminal may determine, as a type of forward/reverse, the direction in which the execution menus are sequentially activated in accordance with the direction selection signal (e.g., left/right or up/down).

Next, in operation S355, the mobile communication terminal may sequentially activate respective execution menus included in the execution menu list in accordance with the computed menu change time or the determined activated direction, and the mobile communication terminal may perform a corresponding execution menu when the touch is released. Here, operation S355 may be performed in the same manner as in operations S235 to S285 of FIG. 2.

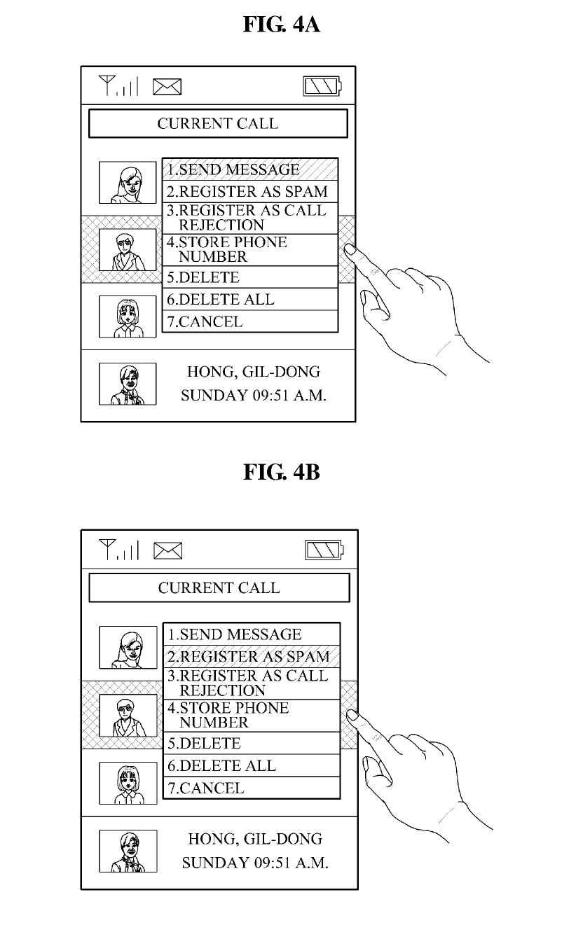

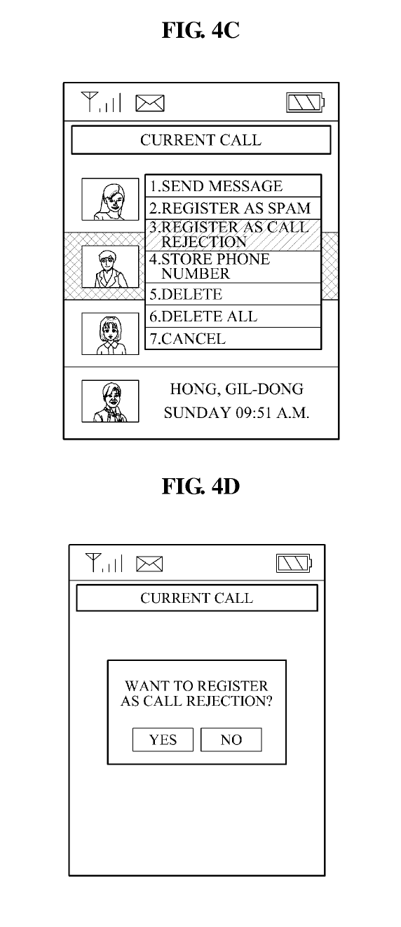

FIG. 4A, FIG. 4B, FIG. 4C, and FIG. 4D are diagrams illustrating a touch interface method of a mobile communication terminal according to an exemplary embodiment of the present invention. More specifically, FIG. 4A, FIG. 4B, FIG. 4C, and FIG. 4D illustrate examples of a screen of the mobile communication terminal according to an exemplary embodiment of the present invention.

Referring to FIG. 4A, a screen shows a displayed execution menu list if a user touches to select one from among persons recently called in a current call history. That is, if the user performs a touch on a selected data of the current call history, and maintains the touch, the mobile communication terminal may display, as illustrated in FIG. 4A, an execution menu list corresponding to the touched data (i.e., a person to be called). Here, the execution menu list may include a send message menu (1. SEND MESSAGE), a register as spam menu (2. REGISTER AS SPAM), a register as call rejection menu (3. REGISTER AS CALL REJECTION), a store phone number menu (4. STORE PHONE NUMBER), a delete menu (5. DELETE), a delete all menu (6. DELETE ALL), and a cancel menu (7. CANCEL). Next, the mobile communication terminal may activate a first execution menu (1. SEND MESSAGE) in the execution menu list. In this instance, if the touch is released by the user, the mobile communication terminal may perform the first execution menu.

Referring to FIG. 4B, a screen shows that a second execution menu (2. REGISTER AS SPAM) is activated if a menu change time elapses while the touch is maintained by the user in the screen of FIG. 4A. As described above, the menu change time may be changed according to a pressure intensity. For example, if the pressure intensity is determined to be greater than a value, the menu change time may be increased or decreased.

Referring to FIG. 4C, a screen shows that the touch is released by the user when a third execution menu (3. REGISTER AS CALL REJECTION) is activated after the menu change time elapses while the touch is maintained by the user in the screen of FIG. 4B.

Referring to FIG. 4D, a screen shows that the activated third execution menu is performed by the user when the touch is released by the user in the screen of FIG. 4C.

The touch interface method according to the above-described exemplary embodiments of the present invention may be recorded in computer-readable media including program commands to implement various operations embodied by a computer. The media may also include, alone or in combination with the program commands, data files, data structures, and the like. Examples of computer-readable media include magnetic media, such as hard disks, floppy disks, and magnetic tape; optical media, such as CD ROM disks and DVDs; magneto-optical media, such as optical disks; and hardware devices that are specially configured to store and perform program commands, such as read-only memory (ROM), random access memory (RAM), flash memory, and the like. Examples of program commands include both machine code, such as produced by a compiler, and files containing higher level code that may be executed by the computer using an interpreter. The described hardware devices may be configured to act as one or more software modules in order to perform the operations of the above-described exemplary embodiments of the present invention, or vice versa.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A mobile communication terminal having a touch interface, the mobile communication terminal comprising:
a touch unit to generate a touch signal in response to a received touch;
a touch signal determination unit to receive the touch signal from the touch unit, and to determine whether the touch is maintained or released; and
an execution menu processing unit to generate an execution menu list with respect to data corresponding to the touch signal if the touch is determined to be maintained, to sequentially activate respective execution menus of the execution menu list in accordance with a menu change time, and to transmit an execution command with respect to the activated execution menu to a control unit to execute the activated execution menu if the touch is determined to be released.

2. The mobile communication terminal of claim 1, wherein the touch unit includes a pressure change sensing module to measure a pressure intensity of the touch to generate a pressure intensity signal, and the execution menu processing unit calculates the menu change time in accordance with the pressure intensity signal.

3. The mobile communication terminal of claim 2, wherein the execution menu processing unit decreases the menu change time in accordance with a pressure intensity signal greater than or equal to a reference pressure intensity.

4. The mobile communication terminal of claim 2, wherein the pressure change sensing module senses a pressure change adjacent to touch position coordinates of the touch to generate a direction selection signal, and the execution menu processing unit activates execution menus in the execution menu list in accordance with the direction selection signal.

5. The mobile communication terminal of claim 1, wherein the execution menu processing unit generates a menu change alarm signal using at least one of a vibration and a sound of the mobile communication terminal when the execution menu is activated.

6. The mobile communication terminal of claim 1, wherein:
if a drag signal is generated before the touch is released, the execution menu processing unit performs a command according to the drag signal,
if a region where the drag signal is generated is included in a touch data region where the touch is maintained, the execution menu processing unit determines that the touch is maintained,
if the region where the drag signal is generated is included in a region where data is absent, different from the touch data region, the execution menu processing unit performs a cancel function, and
if the region where the drag signal is generated is included in another data region, the execution menu processing unit generates an execution menu list with respect to corresponding data, and sequentially activates each execution menu.

7. The mobile communication terminal of claim 1, wherein the execution menu list comprises at least one of execution menus executed for a period with respect to the data, and a number of execution menus arranged in an order of higher execution frequency.

8. The mobile communication terminal of claim 1, wherein the execution menu list is displayed in one of a fan-shape type, a semi-circular type, a horizontal movement type, a vertical movement type, and a semitransparent text type.

9. The mobile communication terminal of claim 1, wherein the execution menu list comprises a cancel menu.

10. The mobile communication terminal of claim 1, wherein the activated execution menu is executed if the touch is released in the activated execution menu of the execution menu list.

11. The mobile communication terminal of claim 1, wherein the execution menu processing unit generates execution menu list comprising execution menus according to recently executed execution menus.

12. The mobile communication terminal of claim 1, wherein the execution menu processing unit generates execution menu list comprising execution menus according to a user history.

13. The mobile communication terminal of claim 1, wherein the execution menu processing unit repeatedly sequentially activates respective execution menus of the execution menu list if it is determined that the touch is maintained.

14. A touch interface method performed in a mobile communication terminal, the touch interface method comprising:
outputting a data list with respect to a menu provided in the mobile communication terminal;
receiving a touch with respect to any one data from the data list;
determining whether the touch is maintained;
generating an execution menu list with respect to the data if the touch is maintained, and displaying the generated execution menu list;
sequentially activating respective execution menus of the execution menu list in accordance with a menu change time; and
performing the activated execution menu if the touch is released.

15. The touch interface method of claim 14, further comprising:
measuring a pressure intensity of the touch to calculate the menu change time.

16. The touch interface method of claim 15, wherein the menu change time is decreased according to a pressure intensity greater than or equal to a reference pressure intensity.

17. The touch interface method of claim 14, further comprising:
sensing a pressure change adjacent to touch position coordinates of the touch to determine an activated direction of the execution menu in the execution menu list.

18. The touch interface method of claim 14, wherein the sequentially activating respective execution menus generates a menu change alarm signal using at least one of a vibration and a sound of the mobile communication terminal if the execution menu is activated.

19. The touch interface method of claim 14, wherein the performing of the activated execution menu comprises performing the activated execution menu if the touch is released in the activated execution menu of the execution menu list.

20. The touch interface method of claim 14, further comprising:
generating a drag signal before the touch is released; and
performing a command according to the drag signal;
wherein the command comprises:
determining that the touch is maintained if a region where the drag signal is generated is included in a touch data region where the touch is maintained,
performing a cancel function if the region where the drag signal is generated is included in a region where data is absent, different from the touch data region, and
generating an execution menu list with respect to data in another data region if the region where the drag signal is generated is included in the another data region.
